(19) United States
(12) Patent Application Publication
(10) Pub. No.: US 2006/0012058 A1
(43) Pub. Date: Jan. 19, 2006

(54) Method for manufacturing microlens and apparatus for manufacturing the same

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/159,109

(22) Filed: Jun. 23, 2005

(30) Foreign Application Priority Data
Jul. 16, 2004 (JP) 2004-209862

(51) Int. Cl. B29D 11/00

(52) U.S. Cl. 264/1.32; 264/1.38; 425/375; 425/174.4

(57) ABSTRACT

A method for manufacturing a microlens includes: ejecting liquid drops containing a material for forming microlenses from a liquid drop ejection head to make the liquid drops land on a substrate; and irradiating the liquid drops with ultraviolet light at least once at a time period between after the ejection of the liquid drops and immediately after the landing of the liquid drops on the substrate. In addition, an apparatus for manufacturing a microlens, includes: a liquid drop ejection head that ejects liquid drops containing a material for forming microlenses; a table that supports a substrate above which the microlenses are to be formed; and an ultraviolet light radiating device that irradiates with ultraviolet light one of: the liquid drops that are flying from the liquid drop ejection head to the substrate; and the liquid drops that has landed on the substrate.

### BACKGROUND OF THE INVENTION

1. Field of the Invention

The present invention relates to a method for manufacturing a microlens and to an apparatus for manufacturing the same.

Priority is claimed on Japanese Patent Application No. 2004-209862, filed Jul. 16, 2004, the content of which is incorporated herein by reference.

2. Description of Related Art

Recently, optical devices having a number of miniature lenses known as microlenses have become available. Examples of such optical devices include, for example, a light-emitting apparatus having a laser, an optical interconnection for an optical fiber, or a solid-state imaging element having a condenser lens for gathering incident light, or the like.

The use of an ink jet method as a method for manufacturing such a microlens has been sought. In this method, liquid drops containing a material for forming microlenses are ejected on a substrate from miniature nozzles provided in an ink jet head, and are then cured to form microlenses.

With the ink jet method, in order to prevent clogging of the miniature nozzles, the liquid material that can be ejected should be one having a relatively low viscosity of 50 cps (mPa·s) or less. When a liquid material with a low viscosity is used, however, the diameter of the resulting microlenses is increased because liquid drops wet and spread on a substrate after they land on the substrate.

Hence, a new technique is studied in which the diameter of liquid drops after landing is controlled by controlling the surface energy of the substrate. Specifically, wetting and spreading of liquid drops after landing is restricted by processing the substrate with a liquid repellency-imparting treatment (for example, see Japanese Unexamined Patent Application, First Publication No. 2003-240911). This technique allows formation of smaller-diameter microlenses.

However, in the above-mentioned method by controlling the surface energy of the substrate, the shape of microlenses is largely dependent on the surface energy of the substrate, limiting flexibility in design. In addition, since microlenses are formed on a substrate which underwent a liquid repellency-imparting treatment, it is difficult to ensure good adhesion between the microlenses and the substrate.

### SUMMARY OF THE INVENTION

The present invention was conceived in order to solve the above-mentioned problems, and an object thereof is to provide a method for manufacturing a microlens and an apparatus for manufacturing the same that can enable manufacturing of small-diameter microlenses while ensuring adhesion between the microlenses and the substrate.

In order to achieve the above-descried object, a method for manufacturing a microlens according to the present invention is a method for manufacturing a microlens that includes: ejecting liquid drops containing a material for forming microlenses from a liquid drop ejection head to make the liquid drops land on a substrate; and irradiating the liquid drops with ultraviolet light at least once at a time period between after the ejection of the liquid drops and immediately after the landing of the liquid drops on the substrate.

With this method, even if the liquid material before ejection has a low viscosity, the viscosity thereof can be increased significantly by irradiating the liquid drops after ejected with ultraviolet light. Thus, wetting and spreading of the liquid drop after it is made to land on the substrate is limited, thereby making formation of small-diameter microlenses possible. In addition, since control of the surface energy of the substrate is not required, a close adhesion between the microlenses and the substrate is ensured.

It should be noted that the material of the microlenses preferably contains an ultraviolet curing resin material as a main component. In particular, the ultraviolet curing resin material is preferably an epoxy resin.

When an ultraviolet curing resin material is used as the material of the microlenses, the viscosity thereof can be increased significantly by irradiating the liquid drops after ejected with ultraviolet light. In particular, the curing rate of epoxy resins by radiation with ultraviolet light is relatively high since epoxy resins cure by cationic polymerization. Thus, the viscosity thereof can be increased significantly by irradiating the liquid drops after ejected with ultraviolet light. In addition, curing shrinkage and the coefficients of linear expansion of epoxy resins are relatively small. Therefore, epoxy resins enable precise formation of microlenses when they are used as an ultraviolet curing resin material.

An apparatus for manufacturing a microlens according to the present invention includes: a liquid drop ejection head that ejects liquid drops containing a material for forming microlenses; a table that supports a substrate above which the microlenses are to be formed; and an ultraviolet light radiating device that irradiates with ultraviolet light one of: the liquid drops that are flying from the liquid drop ejection head to the substrate; and the liquid drops that has landed on the substrate.

With this apparatus, small-diameter microlenses can be formed while ensuring adhesion between the microlenses and the substrate.

### BRIEF DESCRIPTION OF THE DRAWINGS

FIG. 1 is a schematic diagram illustrating a method for manufacturing a microlens and an apparatus for manufacturing the same according to one embodiment.

FIG. 2 is a diagram showing wetting and spreading of liquid drops after landing.

FIG. 3 is a diagram illustrating the liquid repellency-imparting treatment for the substrate.

FIG. 4A is a schematic perspective view of a liquid drop ejection head.

FIG. 4B is a cross-sectional view of the liquid drop ejection head.

FIGS. 5A and 5B are plan views of an apparatus for manufacturing a microlens.

FIG. 6 is a schematic view of a laser printer head.

### DETAILED DESCRIPTION OF THE INVENTION

Hereafter, various embodiments of the present invention will be described with reference to the drawings. In addition, in respective drawings used for the following description, the scale is changed for each member so that each member is of a size which can be depicted in the drawing.

Method for Manufacturing Microlens

FIG. 1 is a schematic diagram illustrating a method for manufacturing a microlens and an apparatus for manufacturing the same according to this embodiment. In the method for manufacturing a microlens of this embodiment, liquid drops 22 containing a material for forming microlenses are ejected from the liquid drop ejection head 34 to make them land on the substrate 5, and the liquid drops 22 are irradiated with ultraviolet light 62 at least once at a time period between after the ejection of the liquid drops 22 and immediately after landing.

Material for Forming Microlens

As a material for forming microlenses, an ultraviolet light curable optical transmitting resin is used. Non-solvent optically transparent resins are preferably used for this optical transmitting resin. Such non-solvent optically transparent resins are prepared by liquefying by diluting with a monomer thereof, for example, instead of dissolving the optically transparent resin in an organic solvent to liquefy the optically transparent resin, thereby making ejection from liquid drop ejection heads possible. In addition, the non-solvent optically transparent resin is made by adding a photopolymerization initiator such as a biimidazole compound in the above optical transmitting resin, so that the resin can be used as a radiation curable type. In other words, addition of the photopolymerization initiator provides the radiation curable resin with a radiation curable characteristic. Here, radiation is a general term which indicates various rays such as visible radiation, ultraviolet light, extreme ultraviolet light, X-rays, and electron beam, and among them, ultraviolet light is generally used.

As particular example of such an optically transparent resin, acrylic resins or epoxy resins, or the like, may be used. Among them, epoxy resins are preferably used. The curing rate of acrylic resins by radiation with ultraviolet light is relatively low since acrylic resins cure by radical polymerization, and curing shrinkage of the resins is relatively large. In contrast, the curing rate of epoxy resins by radiation with ultraviolet light is relatively high since epoxy resins cure by cationic polymerization, and curing shrinkage of the resins is relatively small. Furthermore, when acrylic resins and epoxy resins are compared after curing, the refractive indices and the light transmittances are comparable. However, acrylic resins have relatively large coefficients of linear expansion while the coefficients of linear expansion of epoxy resins are relatively small. Therefore, epoxy resins enable precise formation of microlenses when they are used as a material for forming microlenses.

It is preferable for the surface tension of the optically transparent resin used as the lens material to be within the range of greater than or equal to 0.02 N/m and less than or equal to 0.07 N/m. When ejecting an ink using a liquid drop ejection method, if the surface tension is less than 0.02 N/m, it becomes easy for deviations during ejection of the liquid drops to occur, since the wettability of the lens material with respect to the surface of the nozzle is increased. On the other hand, the surface tension exceeds 0.07 N/m, it becomes difficult to control the ejection amount and the ejection timing, since the shape of the meniscus at the nozzle tip becomes unstable.

In order thus to adjust the surface tension, it will be acceptable to add to the dispersion liquid of the above-described optically transparent resin, in very small amount, within the range in which the contact angle with the substrate 5 does not greatly decrease, a surface tension modifier such as a fluorine-containing, a silicone-containing, or a non-ionic material, or the like. A non-ionic surface tension modifier increases the wettability of the ink to the substrate 5, and improves the quality of leveling of the resulting layer, and is a material which serves to prevent the generation of minute concavities and convexities in this layer. It will also be acceptable, according to requirements, to include an organic compound such as an alcohol, an ether, an ester, a ketone or the like in the above-described surface tension modifier.

It is preferable for the viscosity of the optically transparent resin used as a material of lenses to be greater than or equal to 1 mPa·s and less than or equal to 200 mPa·s. When ejecting the ink as liquid drops using a liquid drop ejection method, if the viscosity is less than 1 mPa·s, the portion surrounding the vicinity of the nozzle can easily be contaminated by the liquid material as it flows out of the nozzle. In contrast, if the viscosity is greater than 200 mPa·s, ejecting the ink is made possible when a mechanism to heat the ink is provided to the head or the liquid drop ejection apparatus. However, it becomes difficult to eject liquid drops in a smooth manner because the hole in the nozzle may be frequently clogged at room temperature. If the viscosity is greater than 200 mPa·s, it is difficult to reduce the viscosity so that liquid drops are ejected even when the ink is heated.

Liquid Drop Ejection and Ultraviolet Light Radiation Steps

Liquid drops containing the above-described lens material is ejected from a liquid drop ejection head that will be described later to make them land above the substrate 5.

As the substrate 5, a glass substrate or a semiconductor substrate, or one of such substrates to which a various functional thin film or functional element are formed, may be used. The surface of the substrate 5 may be flat or curved, and the shape of the substrate is not particularly limited, and substrates with various shapes may be used.

For example, a GaAs substrate to which numerous surface emitting lasers are formed may be used as a substrate. In this case, in the vicinity of emitting end of each of the surface emitting lasers, an insulating layer made of polyimide resin or the like is formed. Then, a base member is provided on a surface on the laser emitting side of each of the surface emitting lasers, and the liquid drops of the lens material are made to land on the base member to form a microlens. Here, as the material for forming the base member, it is preferable to utilize a material which has a light transparent characteristic, in other words, a material that absorbs virtually no light in a wavelength range of the light emitted from the surface emitting lasers 2. This material thus substantially transmits the emitted light. For example, polyimide resins, acrylic resins, fluoro-based resins, or the like may be preferably used, and in particular, polyimide resins are more preferable

Ultraviolet Light Radiation Step

In this embodiment, the ejected liquid drops 22 are irradiated with the ultraviolet light 62 at least once at a time period between after the ejection of the liquid drops 22 and immediately after landing The wavelength of the ultraviolet light 62 is preferably no less than 200 nm and no more than 400 nm in order to apply sufficient energy to the liquid drops. In particular, the wavelength of the ultraviolet light 62 is more preferably no less than 254 nm and no more than 365 nm since the laser light source 60, which is an ultraviolet light radiating device, for this wavelength range is easily available.

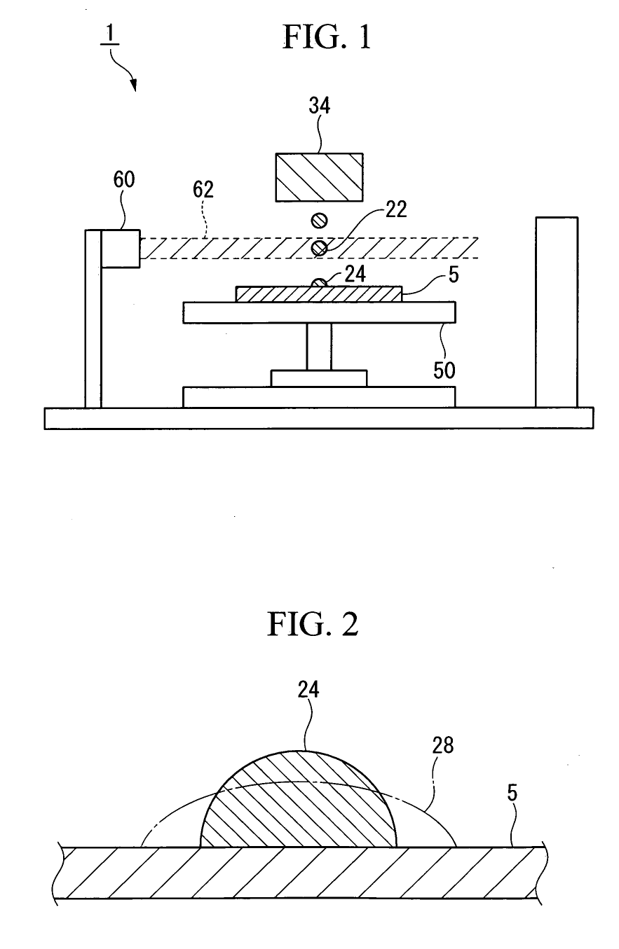

FIG. 2 is a diagram showing wetting and spreading of liquid drops after landing. In general terms, it is required to use a liquid material with a low viscosity liquid for stably ejecting liquid drops from a drop ejection head. Even if the liquid material before ejection has a low viscosity, however, the viscosity thereof can be increased significantly by irradiating the liquid drops after ejected with ultraviolet light. This is because a part of an ultraviolet curing resin that is the lens material is cured by irradiation with ultraviolet light, and because a part of photopolymerization initiators or monomers contained in the liquid drops are cured. By increasing the viscosity of the liquid drops, it is possible to limit wetting and spreading of the liquid drops after landing on the substrate 5. In one example, when a liquid drop having a volume of 5 pL is ejected on a substrate, the diameter of a liquid drop 28 after landing without radiation with ultraviolet light was about 60 μm whereas the diameter of a liquid drop 24 after landing when irradiated with ultraviolet light was about 40 μm. It should be noted that the diameter of liquid drops after landing can also be controlled by adjusting the intensity of the ultraviolet light.

The landed liquid drops are then completely cured by irradiation with ultraviolet light or the like to form a microlens.

As described above, in the method for manufacturing a microlens of this embodiment, the liquid drops are irradiated with ultraviolet light at least once at a time period between after the ejection of the liquid drops and immediately after the landing of the liquid drops. Thus, it is possible to limit wetting and spreading of liquid drops after landing, which allows formation of small-diameter microlenses. Since microlenses can be formed without controlling the surface energy of the substrate 5, i.e., without treating the surface of the substrate 5 with a liquid repellency-imparting treatment, adhesion between the microlenses and the substrate 5 can be ensured.

It should be noted that the ultraviolet light 62 is preferably radiated so that the beam of ultraviolet light 62 is parallel to the substrate 5 on which the liquid drops 22 are ejected, as shown in FIG. 1. In this case, the surface energy of the substrate 5 does not change since the ultraviolet light 62 is not irradiated on the substrate 5. Furthermore, the ultraviolet light 62 is preferably irradiated so that the diameter of an ejected liquid drop 22 is within the beam diameter of the ultraviolet light 62. In this case, the viscosity of the liquid drops 22 is increased evenly, and thus the shape of the liquid drops after landing becomes symmetrical. By this, it is possible to form symmetrical microlenses that exhibit excellent optical characteristics.

Liquid Repellency-Imparting Step

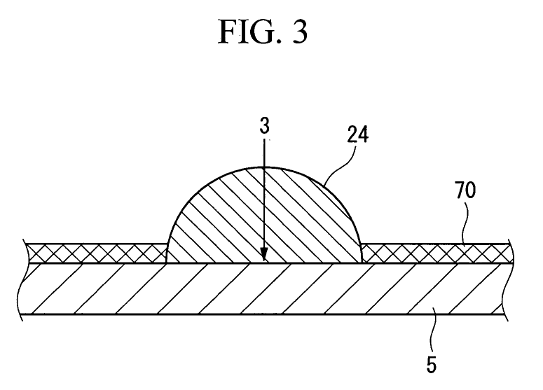

FIG. 3 is a diagram illustrating the liquid repellency-imparting treatment for the substrate. It is preferable to treat a region on the substrate 5 around a region 3 to which a microlens is to be formed prior to the liquid drop ejection step mentioned above with a liquid repellency-imparting treatment. As the liquid repellency-imparting treatment, for example, a method for forming a self-assembled film or plasma treatment or the like, may be used.

In the method for forming a self-assembled film mentioned above, on the surface of the substrate 5 above which an electrically conductive layer wiring pattern is formed, a self assembled layer 70 is formed from an organic molecular film or the like.

The organic molecular film for treating the surface of the substrate includes: a functional group which can be combined with the substrate 5; a functional group which modifies the quality of (i.e., controls the surface energy of) the surface of the substrate 5, i.e., a group having an affinity with liquid or a liquid repelling group positioned at the opposite side of the substrate-combining functional group; and a carbon straight chain which connects together these functional groups, or a carbon chain which branches off from one portion thereof; and it constitutes a molecular film, for example a monomolecular film, which is of the same constitution as the substrate 5, and is combined with the substrate 5.

As used herein, the term “self assembled layer 70” refers to a layer which consists of connecting functional groups which can react with the constituent atoms of the under-layer of the substrate 5 or the like and straight-chain molecules, and which is made by orienting a compound which has extremely high orientability due to interaction of its straight-chain molecules. Since such a self assembled layer 70 is made by orienting mono-molecules, it can be made extremely thin, and moreover it is a very uniform film at a molecular level. In other words, since all its molecules are positioned upon the same film surface, it has a very uniform film surface, as well as being able to impart an excellent liquid repellency or affinity with liquid.

As the above-described compound having high orientability, by using, for example, a fluoro alkyl silane, a self assembled film 70 is formed with the compounds being oriented so that the fluoro alkyl groups are positioned on the surface of the film, and so that a uniform liquid repellency is imparted to the surface of the film.

As compounds for forming the self assembled layer 70, there may be suggested fluoro alkyl silanes (hereinafter referred to as “FASs”) such as hepta-deca-fluoro-1,1,2,2-tetra-hydro-decyl-tri-ethoxy-silane, hepta-deca-fluoro-1,1,2,2-tetra-hydro-decyl-tri-methoxy-silane, hepta-deca-fluoro-1,1,2,2-tetra-hydro-decyl-tri-chloro-silane, tri-deca-fluoro-1,1,2,2-tetra-hydro-octyl-tri-ethoxy-silane, tri-deca-fluoro-1,1,2,2-tetra-hydro-octyl-tri-methoxy-silane, tri-deca-fluoro-1,1,2,2-tetra-hydro-octyl-tri-chloro-silane, tri-fluoro-propyl-tri-methoxy-silane, or the like. These compounds may be used alone, or in a mixture of two or more thereof.

It should be understood that, by using a FAS, it is possible to obtain both good adhesion to the substrate 5 and also the desired liquid repellency.

A FAS is generally expressed by the structural formula: RₙSiX₍₄₋ₙ₎, where n is an integer from 1 to 3 inclusive, and X is a methoxy group, an ethoxy group, a halogen atom or other hydrolytic group or the like. Furthermore, R is a fluoro alkyl group having a structure of (CF₃)(CF₂)ₓ(CH₂)_{y} (where x is an integer from 0 to 10 inclusive, and y is an integer from 0 to 4 inclusive), and, if a plurality of such Rs and/or Xs are combined with Si, it will also be acceptable either for the Rs and/or the Xs to be the same as one another, or alternatively for them to differ from one another. The hydrolytic groups which are expressed as X make a silanol by hydrolysis, and react with hydroxyl groups in the under-layer of the substrate 5 (glass or silicon) by forming a siloxane bond with the substrate 5. On the other hand, since R includes a fluoro group such as (CF₂) or the like upon its surface, it modifies the under surface of the substrate 5 into a non-wetting surface (whose surface energy is low).

The self assembled layer 70 made of an organic molecular film and the like is formed on the substrate 5 when the above-mentioned raw material compound and the substrate are contained in the same sealed container and left for two to three days at room temperature. Alternatively, the self assembled layer 70 is formed in about 3 hours when the entire sealed container is kept at a temperature of 100° C. It should be understood that, although in the above the formation of a self assembled layer 70 from the gas phase is used, such a layer could also be formed from a liquid phase. For example, the self assembled layer 70 may be formed on the substrate by soaking the substrate 5 in a solution which contains the source compound, cleaning it, and drying it.

In addition, it is desirable to perform pretreatment on the surface of the substrate by irradiating with ultraviolet light, or by cleaning it by using a solvent before forming the self assembled layer 70.

In contrast, as plasma treatment method, a plasma processing method (a CF₄ plasma processing method) is preferably used in which tetrafluoromethane is employed as the process gas at ambient atmospheric pressure. As one example of conditions under which such CF₄ plasma processing may be performed, for example, the plasma power may be 50 to 1000 W, the flow rate of the tetrafluoro methane (CF₄) gas may be from 50 to 100 ml/min, the relative shifting speed of the substrate 5 with respect to the plasma discharge electrode may be 0.5 to 1020 mm/sec, and the temperature of the substrate may be 70° C. to 90° C. It should be understood that the process gas should not be considered as being limited to tetrafluoro methane (CF₄); alternatively, it would be possible to utilize some other fluorocarbon gas. By performing this type of liquid repellency-imparting step, fluorine-containing groups are introduced into the surface of the substrate 5, and thereby a high liquid repellency is imparted.

As described above, by ejecting liquid drops 24 on a region to which a microlens is to be formed after providing a liquid repellency-imparting treatment around the region to which a microlens is to be formed, it is possible to limit wetting and spreading of the liquid drops 24. In this way, microlenses can be formed while controlling the diameter thereof further precisely.

Furthermore, as shown FIGS. 2A and B, the shape of the liquid drop 24 that has been irradiated with ultraviolet light is closer to a sphere than that of the liquid drop 28 that has not undergone irradiation with ultraviolet light. A microlens that is shaped closer to a sphere has a shorter focal length. The size of an optical device can be reduced by manufacturing the optical device using a microlens having a short focal length.

Apparatus for Manufacturing Microlens

Next, an apparatus for manufacturing a microlens according to this embodiment will be explained with reference to FIGS. 1, 4A to 5B. As shown FIG. 1, the apparatus for manufacturing a microlens of this embodiment includes: a liquid drop ejection head 34 that ejects liquid drops 22 containing a material for forming microlenses; a table 50 that supports a substrate 5 above which the microlenses are to be formed; and a laser light source 60 that irradiates with ultraviolet light 62 either the liquid drops 22 that are flying from the liquid drop ejection head 34 to the substrate 5 or the liquid drops after landing on the substrate 5.

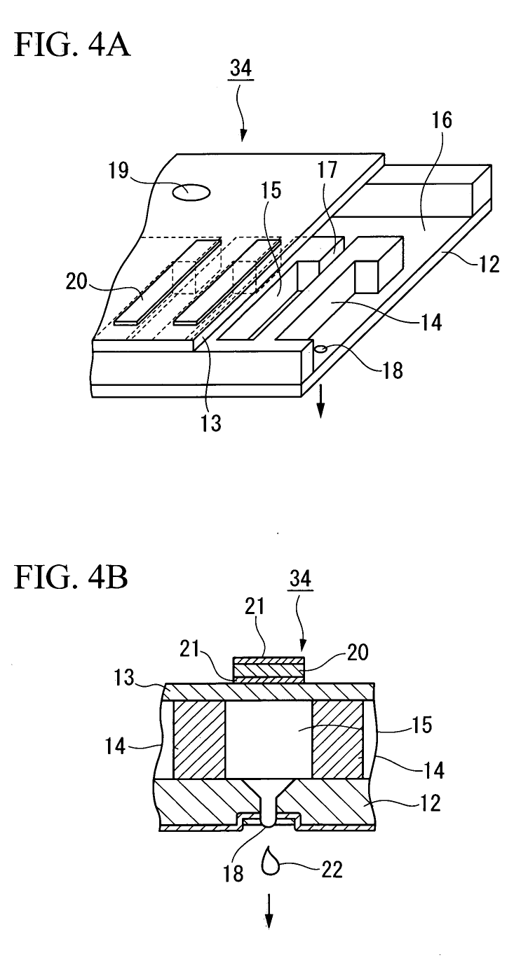

FIG. 4A is a schematic perspective view of a liquid drop ejection head, and FIG. 4B is a cross-sectional view of the liquid drop ejection head.

The apparatus for manufacturing a microlens according to this embodiment includes a liquid drop ejection head 34 that ejects liquid drops containing a material for forming microlenses. As shown in FIG. 4A, this liquid drop ejection head 34 includes a nozzle plate 12 which is for example made of stainless steel, and a vibrating plate 13, and these are connected together via a partition member (a reservoir plate) 14. A plurality of cavities 15 and a reservoir 16 are defined between the nozzle plate 12 and the vibrating plate 13 by the partition member 14, and these cavities 15 and the reservoir 16 are communicated together via flow conduits 17.

Liquid material (material for lens) is filled within the interiors of these cavities 15 and the reservoir 16, and the flow conduits 17 between these have the function of acting as supply orifices which supply the liquid material from the reservoir 16 to the cavities 15. In addition, a plurality of hole-shaped nozzles 18 for ejecting the liquid material from the cavities 15 are formed in the nozzle plate 12 and are arranged in a vertical and horizontal array. On the other hand, a hole 19 is formed in the vibrating plate 13 so as to open within the reservoir 16, and a liquid material tank (not shown in the figures) is connected to this hole 19 via a tube (also not shown).

In addition, piezoelectric elements (piezo elements) 20 are connected to the surface of the vibrating plate 13 which is on the opposite side thereof from the surface which faces towards the cavities 15, as shown in FIG. 4B. These piezoelectric elements 20 are sandwiched between pairs of electrodes 21, and are made so as to flex towards the outside upon the application of electrical power.

The vibrating plate 13 with this structure, and to which the piezoelectric elements 20 are connected, is integral with the piezoelectric elements 20 and flexes towards the outside at the same time as each of them does, so that thereby the volumes of the corresponding ones of the cavities 15 are made to increase. When this occurs, if the interior of the cavities 15 and the interior of the reservoir 16 are communicated, and liquid material is charged into the reservoir 16, and then an amount of the liquid material which corresponds to the proportion by which the volume of the cavity 15 has increased flows from the reservoir 16 via the corresponding flow conduit 17 into that cavity 15.

In addition, when, in this state, supply of electrical power to the piezoelectric element 20 corresponding to that cavity 15 is cut off, the piezoelectric element 20 and the vibrating plate 13 both return to their original states together. Accordingly, the cavity 15 also returns to its original volume, so that the pressure of the liquid material in the interior of that cavity 15 rises, and the liquid material is ejected from the corresponding nozzle 18 as liquid drops 22.

Furthermore, as an ejecting device for the liquid drop ejection head 34, it would also be acceptable to utilize some device other than the above-described electromechanical conversion element employing the piezoelectric elements (piezo elements) 20; for example, it would also be possible to employ a method which utilizes an electro-thermal conversion element as the energy generation element, or a so-called continuous method of an electrification control type or of a pressure vibration type, or an electrostatic attraction method, or a method in which heat was generated in the liquid material by irradiating it with electromagnetic radiation from a laser or the like, and the liquid material was ejected by the action of this generated heat.

Referring again to FIG. 1, a table 50 that supports the substrate 5 on which microlenses are to be formed is provided opposing the nozzle plate of the liquid drop ejection head 34 described above. The liquid drop ejection head 34 and the table 50 can be three-dimensionally shifted relative to each other by means of a driving unit (not shown). Since the liquid drop ejection head 34 and the table 50 can be shifted relative to each other within a horizontal plane, liquid drops can be ejected to any point on the substrate 5. Furthermore, since the liquid drop ejection head 34 and the table 50 are shifted relative to each other in the vertical direction, adjustment of the flying distance of the liquid drops 22 is made possible. Accordingly, liquid drops can be precisely ejected at predetermined positions on the substrate 5.

A laser light source 60, which is an ultraviolet light radiating device, is provided on the side of the liquid drop ejection head 34 and the table 50. This laser light source 60 irradiates with ultraviolet light 62 either the liquid drops 22 that are flying from the liquid drop ejection head 34 to the substrate 5 or the liquid drops after landing on the substrate 5. As the laser light source 60, an ultraviolet light laser light source of a wavelength of no less than 200 nm and no more than 400 nm is preferably used. In particular, an ultraviolet light laser light source that radiates ultraviolet light 62 having a wavelength of no less than 254 nm and no more than 365 nm is easily available at low cost. The laser light source 60 having a beam diameter greater than the diameter of an ejected liquid drop 22 ejected from the liquid drop ejection head 34 is preferably used.

As shown in FIG. 1, the laser light source 60 is provided so that the beam of the ultraviolet light is parallel to the substrate 5 supported on the table 50. This prevents ultraviolet light from being irradiated on the substrate 5. It should be noted that the laser light source 60 is not necessarily fixed to the side of the table 50; the laser light source 60 may be secured to the side of the liquid drop ejection head 34.

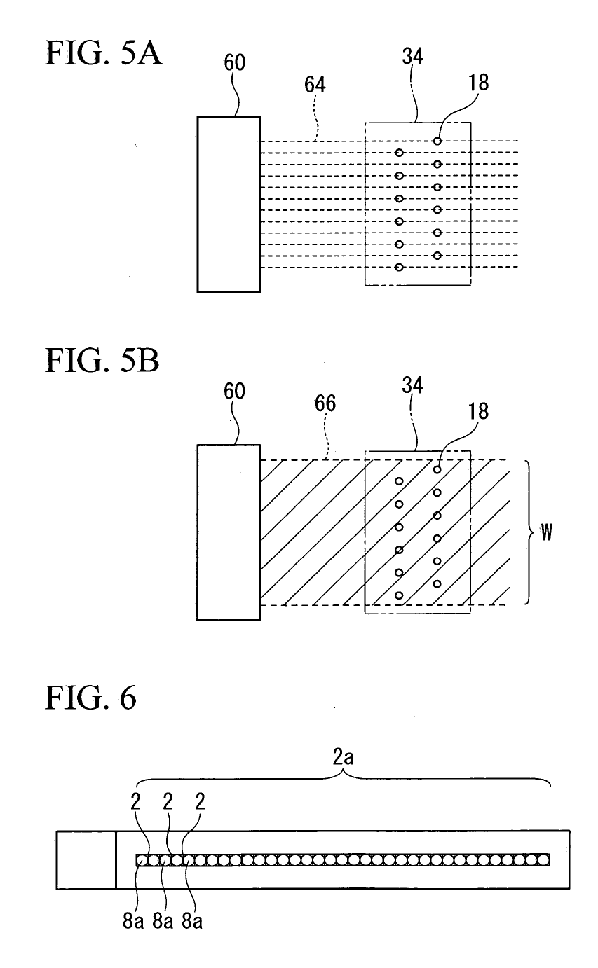

FIGS. 5A and 5B are plan views of an apparatus for manufacturing a microlens. A plurality of nozzles 18 are provided in a row to the liquid drop ejection head 34 so that liquid drops can be ejected from each of the nozzles 18 simultaneously or in different timings, thereby enabling effective formation of multiple microlenses. Accordingly, in order to irradiate liquid drops simultaneously ejected from the plurality of nozzles 18 with ultraviolet light, for example, the laser light source 60 preferably has the following configuration.

A first example uses the laser light source 60 that can irradiate the same number of light beams 64 as the number of nozzles, as shown FIG. 5A. The laser light source 60 is positioned vertically to the direction of the row of the nozzles 18 so that the optical axes of the light beams 64 irradiated from the laser light source 60 come across the flying paths of liquid drops ejected from the respective nozzles 18. By this, even when liquid drops are ejected simultaneously from the plurality of nozzles 18, it is possible to irradiate each of the liquid drops with ultraviolet light.

A second example may use the laser light source 60 that can emit light beams 66 that forms a plane, as shown in FIG. 5B. In this case, it is possible to irradiate with ultraviolet light each of the liquid drops that are ejected simultaneously from the plurality of nozzles 18 without requiring a precise alignment between the flying paths of the liquid drops and the optical axes of the light source.

By using the above-described apparatus for manufacturing a microlens, the viscosity of the liquid drops ejected from the liquid drop ejection head can be increased significantly. Furthermore, wetting and spreading of the liquid drop after it is made to land on the substrate is limited, thereby making formation of small-diameter microlenses possible. In addition, since control of the surface energy of the substrate is not required, a close adhesion between the microlenses and the substrate is ensured.

As shown FIGS. 2A and 2B, the shape of the liquid drop 24 that has been irradiated with ultraviolet light is closer to a sphere than that of the liquid drop 28 that has not undergone irradiation with ultraviolet light since wetting and spreading of the liquid drop after landing is limited. A microlens that is shaped closer to a sphere has a shorter focal length. The size of an optical device can be reduced by manufacturing the optical device using a microlens having a short focal length.

Laser Printer Head

FIG. 6 is a schematic view of a laser printer head. The laser printer head shown in FIG. 6 includes microlenses manufactured by the method for manufacturing a microlens of this embodiment. The laser printer head includes, as an optical device, a surface emitting laser array 2a that is formed by arranging a number of surface emitting lasers 2 in a line, and microlenses 8a that are provided for each of the surface emitting lasers 2 forming the surface emitting laser array 2a. It should be noted that a driving element (not shown), such as a TFT, is provided for the surface emitting lasers 2, and a temperature compensating circuit (not shown) is provided for the laser printer head.

The laser printer head having such a structure is included in a laser printer.

Since such a laser printer head includes microlenses having excellent optical characteristics as described previously, the laser printer head exhibits a good image drawing capability.

Furthermore, since the laser printer includes such a laser printer head having good image drawing capability, the image drawing capability of the laser printer in turns is enhanced.

The technical scope of the present invention is not limited to the above-described embodiments; rather various changes can be made without departing from the spirit of the present invention.

For example, the microlens of the present invention can be applied to various optical devices other than the examples described above. For example, the microlens may be used as an optical component used in a light receiving surface of a solid-state imaging element (CCD), an optical connections for connecting between optical fibers, an optical transmission apparatus, a screen for a projector, a projector system, or the like. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method for manufacturing a microlens, comprising:
ejecting liquid drops containing a material for forming microlenses from a liquid drop ejection head to make the liquid drops land on a substrate; and
irradiating the liquid drops with ultraviolet light at least once at a time period between after the ejection of the liquid drops and immediately after the landing of the liquid drops on the substrate.

2. The method for manufacturing a microlens according to claim 1, wherein the material of the microlenses contains an ultraviolet curing resin material as a main component.

3. The method for manufacturing a microlens according to claim 2, wherein the ultraviolet curing resin material is an epoxy resin.

4. An apparatus for manufacturing a microlens, comprising:
a liquid drop ejection head that ejects liquid drops containing a material for forming microlenses;
a table that supports a substrate above which the microlenses are to be formed; and
an ultraviolet light radiating device that irradiates with ultraviolet light one of:
the liquid drops that are flying from the liquid drop ejection head to the substrate; and the liquid drops that has landed on the substrate.
